(19) United States
(12) Patent Application Publication
(10) Pub. No.: US 2016/0066584 A9
(43) Pub. Date: Mar. 10, 2016

(54) COMPOSITIONS AND METHOD OF CONTROLLING PHYTOPARASITIC PEST POPULATIONS

(71) Applicant: FBSCIENCES HOLDINGS, INC., Collierville, TN (US)

(72) Inventors: David Jackson, Bromyard (GB); Lee Julian Simmons, Tallassee, AL (US)

(73) Assignee: FBSCIENCES HOLDINGS, INC, Collierville, TN (US)

(21) Appl. No.: 14/415,975

(22) PCT Filed: Jul. 18, 2013
(86) PCT No.: PCT/US2013/051072

§ 371 Date: Jan. 20, 2015

Related U.S. Application Data
(60) Provisional application No. 61/674,023, filed on Jul. 20, 2012.

(51) Int. Cl. A01N 65/00; A01N 43/16; A01N 27/00; A01N 43/90

(52) U.S. Cl. CPC A01N 65/00; A01N 43/90; A01N 43/16; A01N 27/00

(57) ABSTRACT

Compositions and methods of phytoparasitic pest population control are provided, the compositions comprise a first component comprising an agriculturally acceptable complex mixture of dissolved organic material characterized by natural organic matter that is of defined composition, suitable for soil, foliar, and seed coating. In one embodiment, the phytoparasitic pest is nematodes.

### TECHNICAL FIELD

Disclosed are compositions and methods for managemerit of phytoparasitic pest populations in soils and agricultural environments, seeds and foliage. Specifically, the compositions and methods comprises contacting a locus of a seed or plant with a composition comprising an agriculturally acceptable complex mixture of dissolved organic material characterized by natural organic matter of defined composition.

### BACKGROUND

Many phytoparasitic pests, for example, nematodes, are known to affect the yield, growth, and health of crops and plants. Nematodes generally are sod-based roundworms that feed as larvae and/or adults on the root system, and other plant parts, resulting in physiological changes to the plant. The physiological changes in the host plant's roots caused by larvae and/or adult nematodes can lead to the formation of galls (“knots”), which causes a disruption of the vascular system of the plant's roots inhibiting growth, Root elongation can stop completely, inadequate supply of water and nutrients provided by the reduced root system can result, causing foliage chlorosis and/or wilt, as well as stunting of growth, any of which can result in low yield or death. Root crops affected by nematodes can lose their marketability because of the non-aesthetic distortions caused by the nematode.

In addition, nematodes can cause physiological effects leading to an increase in the susceptibility of plant roots to bacteria and/or fungi attack, including bacteria and/or fungi the plant would otherwise resist. Such attack can lead to extensive secondary decay and rotting.

Current treatments for nematode population control typically include chemicals, biologicals, and/or non-chemical methods such as Systemic Acquired Resistance Inducers to provide resistant crop strains, GMO's, and Hatching Stimulants and Inhibitors to clear loci prior to planting. Each of the above chemical and biological classes of compounds and methods have one or more drawbacks, including, but not limited to toxicity, cost, availability, reliability, and high application amounts. New nematicides face elevated government regulations and public scrutiny as to their environmental and ecological impact.

While there are thousands of nematode species, certain genera of nematodes have a far greater negative economic impact on agriculture than others. The genera of Nematoda can be ranked with respect to their economic effect, from most economically damaging, to least damaging as follows, Meloidogyne; Heterodera; Protylenchus; Globodera; Tylenchulus; Xiphinema; Rotylenchulus; Radopholus; Ditylenchus; Helicotylenchus, etc. subject to variation by region, climate, and severity. Additional plant parasitic nematode genera capable of significant economical/agronomical damage, include, for example, Anguina, Aphelenchoides, Aphelenchus, Belonolaimus, Brachydorus, Bursaphelenchus, Criconema, Criconemella, Ditylenchus, Globodera, Helicotylenchus, Hemicriconemoides, Hemicycliophora, Heterodera, Hoplolaimus, Langidorus, Meloidegyne, Nacobbus, Paralongidorus, Paratrichodorus, Paratylenchus, Pratylenchoides, Pratylenchus, Psilenchus, Radopholus, Rotylenchulus, Rotylenchus, Scutellonema, Tylenchorhynchus, Tylenchulus, and Xiphinema. Additional plant parasitic nematode of interest in their control include, for example, Acontylus, Aorolaimus Aphasmatylenchus, Atalodera, Atylenchus, Bakernema, Cacopourus, Caloosia, Carphodorus, Cryphadeta, Dolichodorus, Eutylenchus, Gracilacus, Hirschmanniella, Histotylenchus, Hoplotylus, Macratrophurus, Meloidadera, Merlinius, Moruloimus, Nothanguina, Nothotylenchus, Paratrophurus, Peltamigratus, Radopholoides, Rhadinophelenchus, Rotylenchoides, Sarisodera, Sphaeronema, Subanguina, Telotylenchoides, Trichotylenchus, Trophonema, Trophotylenchulus, Trophurus, Tylodorus, and Zygotylenchus. The list includes all antiquated and future taxonomic nomenclature of the same nematode pests While it is difficult to isolate the effect of one pest in an ecological system, the estimated overall average yearly yield loss due to nematodes is estimated at around 10-15% worldwide, with a monetary value estimated in the billions of dollars.

### SUMMARY

There is now provided a composition comprising: a first component comprising an agriculturally acceptable complex mixture of dissolved organic material characterized by natural organic matter that is of defined composition: a second component of at least one agriculturally acceptable microorganism; and at least one optional component selected from agriculturally acceptable herbicides, pesticides, fertilizers, growth regulators, and mixtures thereof effective in controlling phytoparasitic pest populations. Phytoparasitic pests include nematodes, which are controllable by the compositions disclosed herein Phytoparasitic pests include, for example, Anguina spp Aphelenchoides spp Belonolaimus spp Bursaphelenchus spp., Ditylenchus spp., Globodera spp., Heliocotylenchus spp., Heterodera spp., Longidorus spp., Meloidogyne spp., Pratylenchus spp., Radopholus similis, Rotylenchus spp., Trichodorus spp., Tylenchorhynchus spp., Tylenchulus spp., Xiphinema spp, etc.

There is still further provided a method comprising contacting a plant, seed, foliar surface and/or locus of a plant or seed with a first component comprising an agriculturally acceptable complex mixture of dissolved organic material characterized by natural organic matter that is of defined composition, where the first component controls the population of phytoparasitic pests.

### DETAILED DESCRIPTION

Disclosed and described herein is, in part, phytoparasitic pest population control methods comprising the use of an isolated and optionally concentrated natural organic material of defined composition, hereinafter also referred to as the first component. While further reference shall be made specifically to nematodes as an exemplary phytoparasitic pest, the disclosed compositions are generally applicable to other such pests. At least one optional component comprising at least one pesticide (individually or collectively, an insecticide, a fungicide, a bactericide, an anti-viral, plant nutrient, or combinations thereof) can be employed in combination with the first component. Compositions disclosed and described herein vary depending on the intended method of application, the soil composition, nematode populations present, nematode species to which population is to be controlled, growing conditions, weather conditions, and seasonal timing of the plants, as well as other factors.

The term “agriculturally acceptable” applied to as material or composition herein means not unacceptably damaging or toxic to as plant or its environment, and not unsafe to the user or others that may he exposed to the material when used as described herein.

The term “control' or “controlling” or “management” are used interchageably as used herein with specific reference to a phytoparasitic pest is inclusive of repelling, killing, disrupting one or more life cycles, and combinations thereof. Control can include an insignificant amount of phytoparasitic pest “death” yet provide a significant amount of seed and/or plant protection in an environment populated with, phytoparasitic pests. In certain aspects, the control of the phytoparasitic pest is a result of a synergy caused by the contact or impregnating) of the first component with the seed and/or plant defense system, where repelling and/or toxicity of the phytoparasitic pest is at least in part caused by the defense system of the seed and/or plant augmented by the first component. In other aspects, control includes providing the seed and/or plant improved plant health such that regardless of attack and/or damage by the phytoparasitic pest, improvement in one or more of yield, height, weight, or stress resistance of a seed and/or plant is provided compared with untreated seed and/or plant.

The phrase “foliar surface” herein is inclusive of a leaf surface and other green parts of plants having surfaces that may permit absorption of active ingredient, including petioles, stipules, stems, bracts, flowerbuds, etc., and for present purposes “foliar surfaces” will be understood to include surfaces of such green parts.

The phrase “food crop” herein means a crop grown primarily for mammalian consumption. In one aspect, food crop is inclusive of crops grown primarily for human consumption.

The term “granular” and the phrase “granular form” as used herein, refers to granules, particulates, beads, rnicroencapsulation, and combinations thereof. For example, granular forms are those suitable for dispensing equipment commonly used in an agricultural setting. Granular forms may be of any shape or size suitable for use in an agricultural setting or in agricultural equipment.

The term “locus” as used herein is inclusive of a foliar surface and also includes an area in proximity to a plant or the area in which a plurality of seed is or can be sown.

The term “seed” as used herein, is not limited to any particular type of seed and can refer to seed from a single plant species, a mixture of seed from multiple plant species, or a seed blend from various strains within a plant species. The disclosed and described compositions can be utilized to treat gymnosperm seed, dicotyledonous angiosperm seed and monocotyledonous angiosperm seed.

The phrase “seed treatment” as used herein refers generally to contacting a seed with a compound or composition of matter containing or comprising at least one active ingredient (a.i. or AI). The compound or composition of matter may be in any form suitable to the seed, for example, liquid, gel, emulsion, suspension, dispersion, spray, or powder. Seed treatment is inclusive of seed coating and seed dressing.

“Seed coating” or “seed dressing' as used herein are used interchangeably and refer generally to a coating or matrix formed on at least part of the seed, the coating or matrix comprising at least one AI. Optional compounds or agents may be included in the seed coating to facilitate the seed coating process or the disintegration/releasing of the at least one AI from the coating, or to prevent excessive dust-off or to add color to the treated seed. Seed coating includes, alone or in combination, seed buildup, seed encrustment, and seed pelleting operations.

The first component, which can comprise more than 1000 individual compounds, can be of a defined composition, as determined by spectroscopic and elemental analysis, as follows. In one aspect, the defined composition of the first component comprises a mixture of condensed hydrocarbons, lignins, and tannins and/or condensed tannins, and one or more trace metals. in another aspect in combination with the previous aspect, the defined composition of the first component comprises an oxygen-to-carbon ratio for the dissolved organic matter of greater than about 0.5. In another aspect in combination with the previous aspects, the defined composition of the first component comprises a total number of tannin compounds greater than about 200, the tannin compounds having a hydrogen to carbon ration of about 0.5 to about 1.4, and an aramaticity index of less than about 0.7 as measured by mass spectroscopy. In another aspect in combination with the previous aspects, the defined composition of the first component comprises a percent mass distribution of about 47-56 percent lignin compounds, 33-42 percent tannin compounds, and about 8-11 percent condensed hydrocarbon as measured by mass spectroscopy. In another aspect in combination with the previous aspects, the defined composition of the first component comprises a mixture of condensed hydrocarbons, lignins, and tannins and/or condensed tannins, characterized in that at least 20 percent of the total percent of compounds of the composition are tannins and/or condensed tannins. In another aspect in combination with the previous aspects, the defined composition of the first component comprises a mixture of condensed hydrocarbons, lignins, and tannins and/or condensed tannins, characterized in that at least 10 percent of the total percent of compounds of the composition are tannins and/or condensed tannins.

In another embodiment, the first component is of a defined composition inclusive of an oxygen-to-carbon ratio for the dissolved organic matter of greater than about 0.5; a total number of tannin compounds greater than about 200, the tannin compounds having a hydrogen to carbon ration of about 0.5 to about 1.4, and an aromaticity index of less than about 0.7 as measured by mass spectroscopy; a percent mass distribution of about 47-56 percent lignin compounds, 33-42 percent tannin compounds, and about 8-11 percent condensed hydrocarbon as measured by mass spectroscopy.

In another embodiment, the first component is of a defined composition inclusive of an oxygen-to-carbon ratio for the dissolved organic matter of greater than about 0.5; a total number of tannin compounds greater than about 200, the tannin compounds having a hydrogen to carbon ration of about 0.5 to about 1.4, and an aromaticity index of less than about 0.7 as measured by mass spectroscopy; a percent mass distribution of about 47-56 percent lignin compounds, 33-42 percent tannin compounds, and about 8-11 percent condensed hydrocarbon as measured by mass spectroscopy; a mixture of condensed hydrocarbons, lignins, and tannins and/or condensed tannins, characterized in that at least 20 percent of the total percent of compounds of the composition are tannins and/or condensed tannins; and a mixture of condensed hydrocarbons, lignins, and tannins and/or condensed tannins, characterized in that at least 10 percent of the total percent of compounds of the defined composition are tannins and/or condensed tannins.

Compositions comprising the first component and optional additional components disclosed and described herein can take the form of aqueous solutions, oil-in-water emulsions, or water-in-oil emulsions, dispersions, powders, seed coatings, or polymer-containing coatings.

In one aspect, the first component comprises a mixture of organic molecules isolated and extracted from sources rich in natural organic matter into an aqueous solution. The natural organic matter is primarily derived from plant materials that have been modified to varying degrees over time in a soil environment. Some of the plant materials have been recently deposited in the environment. At least a part of the natural organic matter has passed through a partial process of humification to become partially humified natural organic matter. Humification includes microbial, fungal, and/or environmental (heat, pressure, sunlight, lightning, fire, etc,) degradation and/or oxidation of natural organic matter. Most preferably, the first component contains natural organic matter that has not substantially undergone humification (e.g only partially humified natural organic matter of defined composition). In one aspect, the natural organic matter is obtained from environments typically containing or providing anywhere between about 5 ppm, to about 500 ppm of dissolved organic matter (DOM). In other aspects, the natural organic matter is obtained from environments typically containing or providing between about 500 ppm to about 3000 ppm or more DOM. Most preferably, the composition of matter contains natural organic matter that has not substantially undergone humification (partially humified natural organic matter). In one aspect, the natural organic matter is obtained from environments typically containing or providing 5 ppm, 10 ppm, 15 ppm, 20 ppm, 25 ppm, 30 ppm, 35 ppm, 40 ppm, 45 ppm, 50 ppm. 55 ppm, 60 ppm, 65 ppm, 70 ppm, 75 ppm, 80 ppm, 85 ppm, 90 ppm, 95 ppm, 100 ppm, or up to 500 ppm of dissolved organic matter (DOM). In other aspects, the natural organic matter is obtained from environments typically containing or providing about 500 ppm, 1000 ppm, 1500 ppm, 2000 ppm, 2500 ppm, 3000 ppm or more DOM.

Natural organic matter is extremely complex, with thousands of compounds generally present, depending upon the source and the environmental conditions prevalent about the source. Humic substances such as Fulvic Acid (CAS No. 479-66-3) and Humic Acid (CAS No. 1415-93-6) are examples of organic complexes that are derived from natural organic matter, however, the first component is chemically and biologically unique from Fulvic and Hurnic acid, as detailed below.

The first component contains dissolved organic matter, the organic matter being formed during the process of humification as described above, such as microbial, fungicidal, and/or environmental (heat, pressure, sunlight, lightning, fire, etc.) degradation processes. Other natural or synthetic natural organic matter degradation processes may be involved or may be used. In one aspect, the first component contains predominately natural organic matter that has not undergone substantial humification (e.g., partially humified natural organic matter). The amount of humification may be determined and characterized using known methods, for example, by 13C NMR using controls of fully or completely humified natural organic matter, such as humic substances standards from the International Humic Substances Society, for example, Leonardite Humic Acid (LHA), Pahokee Peat Humic Acid (PPHA), and Suwannee River Fulvic Acid II (SRFA). (

In one aspect, the first component is a complex mixture of polymeric polyhydroxy acids (“CPPA”) that is obtained by removing a natural organic matter from its source, optionally processing, and/or concentrating to provide a CPPA composition having a dissolved organic matter (DOM) concentration level of about 10×, 25×, 50×, 100×, 200×, 300×, 400×, 500×, 600×, 700×, 800×, 900×, 1000×, 1500×, 2000×, 2500×, 3000×, 3500×, 4000×, 4500×, or 5000× relative to its original source. In another aspect, CPPA concentrations of dissolved organic matter (DOM) concentration level can be about 7500×, 10,000×, 15,000×, 20,000×, 25,000×, and up to 50,000×. CPPA compositions may be adjusted such that the concentration of DOM is between about 10 ppm to about 700,000 ppm. Preferably, CPPA may be adjusted such that the concentration of DOM is between about 1000 ppm to about 500,000 ppm, CPPA compositions may be adjusted to a DOM value represented by any ppm value between 1000 ppm and 50,000 ppm, inclusive of any ppm value in 500 ppm increments (e.g., 10,500 ppm, 11,000 ppm, 11,500 ppm, 12,000 ppm, etc.) in aqueous solution. Other DOM concentrations may be used, for example, an extremely concentrated composition of between about 75,000 ppm and about 750,000 ppm can be prepared. For example, a concentrate of about 30,000× that of the original source can contain about 550,000 ppm of DOM. In certain aspects, CPPA compositions are approximately between about 91 percent to about 99 percent water, the remaining organic material being primarily DOM with minor amounts of alkali-, alkali earth-, and transition metal salts In yet other aspects, the DOM of the CPPA composition has been dried or lyophilized in a form suitable for reconstitution with an aqueous solution.

Prior to or subsequent to the processes described above, metal ions can be removed and/or additional metal ions can be added to the CPPA to provide a CPPA product that can be adjusted to a predetermined amount or ratio of metal ion to either of the natural organic material (NOM) or to the DOM or the total organic carbon (TOC).

The first component is a complex mixture of substances, typically a heterogeneous mixture of compounds for which no single structural formula will suffice. Elemental and spectroscopic characterization of the first component differentiates it from most other humic-based organic complexes, such as Humic and Fulvic Acids, as further discussed below. Blending of individual batches of the first component may be performed to provide consistency and to compensate for the normal variations of a naturally-derived material.

Detailed chemical and biological testing has shown that the complex mixture of substances of the first component is a unique composition both in its biological effect on plants and its chemical composition compared to Humic and Fulvic acids.

### Characterization Methods for the First Component

The organic compounds making up the first component of the composition, can be characterized in a variety of ways (e.g., by molecular weight, distribution of carbon among different functional groups, relative elemental composition, amino acid content, carbohydrate content, etc.). In one aspect, the first component was characterized relative to known standards of humic-based substances.

For purposes of characterizing carbon distribution among different functional groups, suitable techniques include, without limitation, 13C-NMR, elemental analysis, Fourier transform ion cyclotron resonance mass spectroscopy (FTICR-MS) and Fourier transform infrared spectroscopy (FTIR). The chemical characterization of the first component and Humic substance standards were carried out using Electro spray Ionization Fourier Transform Ion Cyclotron Resonance Mass Spectroscopy (ESI-FTICR-MS), Fourier Transform Infrared Spectroscopy (FTIR) and elemental analysis for metals using ICP-AES, conducted by Huffman Laboratories, Inc. and the University of Washington.

Elemental, molecular weight, and spectroscopic characterization of the first component is consistent with an organic complex that consists primarily of lignin and tannin compounds (and mixtures of condensed and un-condensed tannin), condensed aromatics and trace amounts of lipid and inorganics. Thousands of compounds are present, with molecular weights ranging from 225 to 700 daltons, the majority of compounds having between about 10 to about 39 carbon atoms per molecule. The first component is generally composed of carbon, oxygen, and hydrogen, with small amounts of nitrogen, and sulfur. The first component may also contain potassium and iron at levels above about 5 weight percent.

The elemental composition of the dissolved solids typically present in the first component is given in Table A. If the organic compounds are separated from the inorganic elements, the elemental breakdown is C 55 percent, H 4 percent, O 38 percent, N 1.8 percent, and S 2.2 percent.

TABLE A
Average Elemental Composition of dissolved solids in a
representative sampling of first component, based upon
average values from 10 different lots.

| Element | % |
|---|---|
| Carbon | 35.1 |
| Oxygon | 24.6 |
| Hydrogen | 2.5 |
| Sulfur | 2.1 |
| Nitrogen | 1.3 |
| Potassium | 27.3 |
| Iron | 6.1 |
| Calcium | 0.2 |
| Sodium | 0.2 |
| Phosphorous | 0.1 |
| Other | 0.5 |

Among the classes of organic compounds present in the first component, preliminary analysis generally revealed that there are lignin and tannin (mixture of condensed and uncondensed), condensed aromatics, unidentified substances and some lipids present. Each of these classes of compounds is further characterized by a rather narrow Mw range and number of carbons/molecule. The breakdown of the number and percentage of each of the various compound classes, their MW's and carbon atoms/molecule (Carbon Range) for a first representative sampling of the first component is given in Table B1.

TABLE B1
Compound Classes in the first component, along with size and carbon
ranges for compounds in each class. Based upon composite of 3 different
production batches. Results for individual batches are very similar.

| | | | Size Range | Carbon |
|---|---|---|---|---|
| Compound Class | # Compounds | % of Total | (daltons) | Range |
| Lignin | 1139 | 57 | 226-700 | 11 to 39 |
| Tannin | 587 | 30 | 226-700 | 10 to 31 |
| Condensed | 220 | 11 | 238-698 | 13 to 37 |
| Aromatic | | | | |
| Lipid | 18 | 1 | 226-480 | 14 to 30 |
| Carbohydrate | 1 | 0 | 653 | 24 |
| Other | 23 | 1 | 241-651 | 12 to 33 |

A breakdown of the number and percentage of each of the various compound classes, their MW's and carbon atoms/molecule (Carbon Range) for a second representative sampling based upon an average of 3 different production batches for the first component is given in Table B2.

TABLE B2
Compound Classes in the first component, along with size and carbon
ranges for compounds in each class. Based upon average of 3 different
production batches. Results for individual batches are very similar.

| Compound | | Percent | Size Range | |
|---|---|---|---|---|
| Class | # Compounds | of Total | (daltons) | Carbon Range |
| Lignin | 711 | 56 | 226-700 | 11 to 39 |
| Tannin | 410 | 33 | 226-700 | 10 to 31 |
| Condensed | 122 | 10 | 238-698 | 13 to 37 |
| Aromatic | | | | |
| Lipid | 12 | ~1 | 226-480 | 14 to 30 |
| Carbohydrate | 1 | 0 | 653 | 24 |
| Other | 14 | ~1 | 241-651 | 12 to 33 |

Table C, summarizes the oxygen-to-carbo (O/C) and hydrogen-to-carb (H/C) ratios used in defining the classes described above.

TABLE C
Elemental Ratios and chemical classifications used in
characterizing samples of the first component.

| Class | O/C | H/C | Aromaticity Index |
|---|---|---|---|
| Lignin | 0.15-0.6 | 0.6-1.7 | <0.7 |
| Tannin | 0.6-1.0 | 0.5-1.4 | <0.7 |
| Condensed Aromatic | 0.1-0.7 | 0.3-0.7 | >0.7 |
| Lipid | 0-0.2 | 1.8-2.2 | |
| Carbohydrate | 0.6-1.0 | 1.8-2.2 | |

Comparison with Humic Substance Standards

Comparative elemental and structural characterization of Humic Substances verses samples of the first component were performed. Three humic substances standards from the International Humic Substances Society were used: Leonardite Humic Acid (LHA) Pahokee Peat Humic Acid (PPHA), and Suwannee River Fulvic Acid II (SRFA). Each humic substance standards and each sample of the first component was analyzed by FTIR and ESI-FTICR-MS. A portion of each hurnic substance standard was dissolved in water/methanol, with ammonium ions added for ionization enhancement, for the ESI-FTICR-MS analysis. Three samples of the first component (#1, #2, and #3) were prepared for analysis with cation exchange resin (AG MP-50, Bio-Rad Laboratories, Hercules, Calif.). Comparison of the Humic Suitstance standards and each sample of the first component is presented in Table D.

TABLE D
Comparison of humic substance standards with three samples
of the first component.

| Sample | O/C | H/C | DBE | Avg. MW |
|---|---|---|---|---|
| Suwannee River Fulvic Acid (SRFA) | 0.39 | 1.01 | 12.7 | 445.7 |
| Pahokee Peat Humic Acid (PPHA) | 0.34 | 0.75 | 16.29 | 429.8 |
| Leonardite Humic Acid (LHA) | 0.3 | 0.79 | 15.8 | 423.6 |
| #1 | 0.54 | 0.87 | 13.7 | 472.9 |
| #2 | 0.54 | 0.89 | 13.23 | 456.9 |
| #3 | 0.5 | 0.91 | 13.23 | 455.7 |

Table D indicates that there are major differences between the Humic Substances standards and the samples representing the first component. For example, the O/C ratio is less than 0.4 in all of the Humic Substances but is at least 0.5 for the first component samples. The DBE for the samples is also significantly lower than for the Humic Acid Standards and the average MW is greater.

Based on mass spectral analysis, there are a number of compounds present in the first component samples that are substantially absent or greatly reduced in the Humic Substance standards. In particular, at least one component of the first component may correspond with one or more tannin compounds. By comparison, in the Humic Substance standards, the percent of tannin compounds are present in a small amount. For example, in the Fulvic Acid standard and in the Humic Acid standards, both standards are at least 3×-4× less than the percent tannins found in the first component samples, as shown in Table E.

TABLE E
Number and percent tannins in Humic Substance Standards
verses first component samples.

| | | percent of |
|---|---|---|
| Sample | # tannins | tannin compounds |
| Suwannee River Fuivic Add (SRFA) | 192 | 8.8 |
| Pahokee Peat Humic Acid (PPBA) | 9 | 1.2 |
| Leonardite Humic Acid (LHA) | 22 | 1.2 |
| #1 | 441 | 35.2 |
| #2 | 357 | 34.6 |
| #3 | 432 | 28.3 |

Comparing the Fourier Transform Infrared (FTIR) spectra for the IHSS standards and first component samples, there are similarities, primarily in the region from 1600 to 1800 cm-1. In both sets of samples we see a very strong peak at around 1700 cm-1 due to the C═O stretch from a carboxyl functional group and a peak in the 1590 to 1630 region which is consistent with a C═C bond from alkenes or aromatics. However, significant differences in the region from 700 to 1450 cm-1 are observed. Peaks at 1160 to 1210 are present in all the spectra and are from the C—O bond of alcohols, ethers, esters and acids. The biggest difference is the peak at 870 cm-1 in the first component samples, which is absent in the IHSS standards. This peak may be due to the C—H bond of alkenes and aromatics.

Based on the characterization data, the first component may contain relatively small molecules or supramolecuiar aggregates with a molecular weight distribution of about 300 to about 18,000 daltons or greater. Included in the organic matter from which the mixture of organic molecules are fractionated are various humic substances, organic acids and microbial exudates. The mixture is shown to have both aliphatic and aromatic characteristics. illustratively, the carbon distribution shows about 35 percent in carbonyl and carboxyl groups; about 30 percent in aromatic groups; about 18 percent in aliphatic groups, about 7 percent in acetal groups; and about 12 percent in other heteroaliphatic groups.

In sonic embodiments, the mixture of compounds in the first component comprises organic molecules or supramolecular aggregates with a molecular weight distribution of about 300 to about 30,000 daltons, for example, about 300 to about 25,000 daltons, about 300 to about 20,000 daltons, or about 300 to about 18,000 daltons.

Characterizing carbon distribution among different functional groups, suitable techniques can be used, including without limitation, 13C-NMR, elemental analysis, Fourier transform ion cyclotron resonance mass spectroscopy (FTICR-MS) and Fourier transform infrared spectroscopy (FTIR).

In one aspect, carboxy and carbonyl groups together account for about 25 percent to about 40 percent, for example about 30 percent to about 37 percent, illustratively about 35 percent, of carbon atoms in the mixture of organic compounds of the first component.

In one embodiment, aromatic groups account for about 20 percent to about 45 percent, for example about 25 percent to about 40 percent or about 27 percent to about 35 percent, illustratively about 30 percent, of carbon atoms in the mixture of organic compounds of the first component.

In one embodiment, aliphatic groups account for about 10 percent to about 30 percent, for example about 13 percent to about 26 percent or about 15 percent to about 22 percent, illustratively about 18 percent, of carbon atoms in the mixture of organic compounds of the first component.

In one embodiment, acetal and other heteroaliphatic groups account for about 10 percent to about 30 percent, for example about 13 percent to about 26 percent or about 15 percent to about 22 percent, illustratively about 19 percent, of carbon atoms in the mixture of organic compounds of the first component.

In one aspect, the ratio of aromatic to aliphatic carbon is about 2:3 to about 4:1, for example about 1:1 to about 3:1 or about 3:2 to about 2:1 in the first component.

In a particular illustrative aspect, carbon distribution in the mixture of organic compounds of the first component is as follows: carboxy and carbonyl groups, about 35 percent; aromatic groups, about 30 percent; aliphatic groups, about 18 percent, acetal groups, about 7 percent; and other heteroaliphatic groups, about 12 percent.

Elemental composition of the organic compounds of the first component is independently in one series of embodiments as follows, by weight: C, about 28 percent to about 55 percent, illustratively about 38 percent; H, about 3 percent to about 5 percent, illustratively about 4 percent; O, about 30 percent to about 50 percent, illustratively about 40 percent; N, about 0.2 percent to about 3 percent, illustratively about 1.5 percent; S, about 0.2 percent to about 4 percent, illustratively about 2 percent.

Elemental composition of the organic compounds of the first component is independently in another series of embodiments as follows, by weight: C, about 45 percent to about 55 percent, illustratively about 50 percent; H, about 3 percent to about 5 percent, illustratively about 4 percent; O, about 40 percent to about 50 percent, illustratively about 45 percent; N, about 0.2 percent to about 1 percent, illustratively about 0.5 percent; S, about 0.2 percent to about 0.7 percent, illustratively about 0.4 percent.

In a particular illustrative aspect, elemental distribution is, by weight: C, about 38 percent; H, about 4 percent; O, about 40 percent; N, about 1.5 percent; and S, about 2 percent. The balance consists mainly of inorganic ions, principally potassium and iron in the first component.

In another particular illustrative aspect, elemental distribution is, by weight: C, about 50 percent; H, about 4 percent; O, about 45 percent; N, about 0.5 percent; and S, about 0.4 percent in the first component.

Among classes of organic compounds that can also be present in the first component are, in various aspects, amino acids, carbohydrates (monosaccharides, disaccharides and polysaccharides), sugar alcohols, carbonyl compounds, polyamines, lipids, and mixtures thereof. These specific compounds typically are present in minor amounts, for example, less than 5 percent of the total percent of compounds.

Examples of amino acids that can be present include without limitation arginine, aspartic acid, glutamic acid, glycine, histidine, isoleucine, serine, threonine, tyrosine and valine.

Examples of monosaccharide and disaccharide sugars that can be present include without limitation glucose, galactose, mannose, fructose, arabinose, ribose and xylose.

Based on the above chemical, elemental and structural characterization, the first component is chemically and biologically unique from Humic and Fulvic acids or combinations thereof. Further, as a result of the nature and extent of gene regulation and overall effect of the first component with respect to improved plant health, drought, salinity, and pest-stress resistance, it is generally believed that the first component is unique to that of known humic and/or fulvic acid compositions and treatments, for which such activity and properties are generally lacking in quality and quantity. Other beneficial plant function attributes of the first component may be present or result from gene regulation of the plant's natural defenses obtained from the first component and/or the ability of the first component to act as an effective nematicide.

A suitable mixture of organic compounds can be found in products marketed as Carbon Boost-S soil solution and KAFE™-F foliar solution (Floratine Biosciences, Inc., Collierville, Tenn.) the active ingredient having CAS Reg. No.1175006-56-0. In one aspect, a highly concentrated form of this product and the DOM is preferred. The amount of the first component that should be present in the composition depends on the particular organic mixture used. The amount should not be so great as to result in a physically unstable composition, for example by exceeding the limit of solubility of the mixture in the composition, or by causing other essential components to fall out of solution. On the other hand, the amount should not be so little as to fail to provide enhanced nodulation, emergence, root development, nutrition, growth, enhanced stress resistance, or enhanced disease protection when applied to a target plant species. For any particular organic mixture, one of skill in the art can, by routine formulation stability and bioefficacy testing, optimize the amount of organic mixture in the composition for any particular use.

In one aspect, the first component is obtained by removing a natural organic matter from its source, optionally processing, and/or concentrating to provide the first component having a dissolved organic matter (DOM) concentration level of from anywhere between about 10× to about 5000× relative to its original source concentration. In another aspect, the first component concentrations of dissolved organic matter (DOM) concentration level can be between about 7500× up to about 50,000×. The first component may be adjusted such that the concentration of DOM is between about 10 ppm to about 700,000 ppm. Preferably, the first component may be adjusted such that the concentration of DOM is between about 1000 ppm to about 500,000 ppm. The first component may be adjusted to a DOM value represented by any ppm value between 1000 ppm and 50,000 ppm, inclusive of any ppm value in 500 ppm increments (e.g., 10,500 ppm, 11,000 ppm, 11,500 ppm, 12,000 ppm, etc.) in aqueous solution. Other DOM concentrations may be used, for example, an extremely concentrated composition of between about 75,000 ppm and about 750,000 ppm can be prepared. For example, a concentrate of about 30,000× of the original source can contain about 550,000 ppm of DOM. In certain aspects, the first component are approximately between about 91 percent to about 99 percent water, the remaining organic material being primarily DOM with minor amounts of alkali-, alkali earth-, and transition metal salts. In yet other aspects, the DOM of the first component has been dried or lyophilized in a form suitable for reconstitution with an aqueous solution.

Optionally, additional components, e.g., second component can be present in a composition of the present disclosure together with the first component as describe above. For example, the composition can further comprise as an optional component, at least one agriculturally acceptable pesticide. Additional sources of these nutrients can be present, if desired.) Examples of other plant nutrients, sources of which can optionally be included, are potassium (K), and sulfur (S), phosphorus (P), calcium (Ca), magnesium (Mg), iron (Fe), zinc (Zn), manganese (Mn), copper (Cu) and boron (B).

Advantageously, multivalent cations such as Ca⁺², Mg₊₂, Mn⁺², or Fe^{+2/3} can be added to an aqueous composition containing the first component either in the concentrate or the diluted form. The first component, and at least some of its mixture of compounds, are generally known to complex with one or more multivalent cations such as Ca, Mg, Mn, or Fe, such complexes can substantially improve the efficacy of the first component and/or maintain the potency of the second component (e.g., pesticide) compared to a solution comprising the multivalent cations and pesticide in the absence of the first component.

Other ingredients can optionally be present in a composition disclosed and described herein, including such conventional formulation adjuvants as surfactants (for example to enhance wetting of seed or foliar surfaces), antifoarn agents, spray drift, controlling agents, viscosity modulating agents, antifreezes, coloring agents, penetrates, etc. Any of these can be added if desired, so long as they do not desta bilize essential components of the composition.

### Second Component

An optional second component can be employed, which can be at least one of a pesticide, where the term “pesticide” herein refers to at least one of bactericides, fungicides, insecticides (including acaricides and other nematicides), attractants, sterilizing agents, growth regulating substances, herbicides, safeners, fertilizers, or semiochemicals. Examples of optional second components are provided below.

Bactericides: Bronopol, dichlorophen, nitrapyrin, nickel dimethyl dithiocarbamate, kasugamycin, octhilinone, furancarboxylic acid, oxytetracycline, probenazole, streptomycin, tecloftalam, copper sulphate and other copper preparations.

Fungicides: inhibitors of Nucleic Acid Synthesis for example, benalaxyl, benalaxyi-M, bupirimate, chiralaxyl, clozylacon, dimethirimol, ethirimol, furalaxyl, hyniexazol, metalaxyl, metalaxyl-M, ofurace, oxadixyl, oxolinic acid; Inhibitors of Mitosis and Cell Division for example, benomyl, carbendazim diethofencarb, fuberidazoie, pencycuron, thiabendazole, thiophanate-methyl, zoxamide; Inhibitors of Respiratory Chain Complex I for example, diflumetorim; Inhibitors of Respiratory Chain Complex II for example,boscalid, carboxin, fenfuram, flutolanil, furametpyr, mepronil, oxycarboxin, penthiopyrad, thifluzamide; Inhibitors of Respiratory Chain Complex III for example, azoxystrobin, cyazofamid, dimoxystrobin, enestrobin, famoxadone, fenamidone, fluoxastrobin, kresoxim-methyl, metominostrobin, orysastrobin, pyraclostrobin, picoxystrobin, trifioxystrobin Decouplers dinocap, fluazinam; Inhibitors of ATP Production for example, fentin acetate, fentin chloride, fentin hydroxide, silthiofam; Inhibitors of Amino Acid Biosynthesis and Protein Biosynthesis for example,andoprim, blasticidin-S, cyprodinil, kasugamycin, kasugamycin hydrochloride hydrate, rnepanipyrim pyrimethanil; Inhibitors of Signal Transduction for example, fenpiclonil fludioxonil, quinoxyfen; Inhibitors of Lipid and Membrane Synthesis for example, chlozolinate, iprodione, procymidone, vinclozolin ampropylfos, potassium-ampropylfos, edifenphos, iprobenfos (IBP), isoprothiolane, pyrazophos tolclofos-methyl, biphenyl iodocarh, propamocarb, propamocarb hydrochloride; Inhibitors of Ergosterol Biosynthesis for example, fenhexamid, azaconazole, bitertanol, bromuconazole, cyproconazole, diclobutrazole, difenoconazole, diniconazole, diniconazole-M, epoxiconazole, etaconazole, fenbuconazole, fluquinconazole, flusilazole, flutriafol, furcoriazole, furconazole-cis, hexaconazole, irnibenconazole, ipconazole, metconazole, myclobutanil paclobutrazole, penconazole, propiconazole, prothloconazole, simeconazole, tebuconazole, tetraconazole, triadimefon, triaclimenol, triticonazole, uniconazole, voriconazole, imazalii, imazalil sulphate, oxpoconazole, fenarirnol, flurprimidole, nuarimol, pyrifenox, triforine, pefurazoate, prochioraz, triflumizole, viniconazole, aldirrwrph, dodernorph, dodernorph acetate, fenpropirnorph, tridemorph, fenpropiclin, spiroxarnine, naftifine, pyributicarb, terbinafine; lnhibitors of Cell Wall Synthesis for example, benthiavalicarb, bialaphos, climethornorph, flurnorph, iprovalicarb, polyoxins, polyoxorirn, validamycin A; Inhibitors of Melanin Biosynthesis for example, carproparmid, diclocymet, fenoxanil, phthalide, pyroquilon, tricyclazole; Resistance Inductors for example, acibenzolar-S-methyl, probenazole, tiadinil Multisite captafol, captan, chlorothalonil, copper salts such as: copper hydroxide, copper naphthenate, copper oxychloride, copper sulphate, copper oxide, oxine-copper and Bordeaux mixture, dichlofluanid, dithianon, dodine free base, ferbam, folpet, fluorofolpet, guazatine, guazatine acetate, iminoctadine, iminoctadine albesilate, iminoctadine triacetate, mancopper, mancozeb, maneb, metiram, metiram zinc, propineb, sulphur and sulphur preparations containing calcium polysulphide, thiram, tolylfluanid, zineb, ziram; Actives of Unknown Mechanism for example, amibromdol, benthiazole, bethoxazin, capsimycin, carvone, chinomethionat, chloropicrin, cufraneb, cyfluferiamid, cymoxanil, dazomet, debacarb, diclomezine, dichlorophen, dicloran, difenzoquat, difenzoquat methyl sulphate, diphenylamine, ethaboxam, ferimzone, flumetover, flusulpharnide, fluopicolide, fluoroirride, hexachlorobenzene, 8-hydroxyquinoline sulphate, irumamycin, methasulphocarb, metrafenone, methyl isothiocyanate, mildiornycin, natamycin, nickel dimethyl dithiocarbamate, nitrothal-isopropyl, octhilinone, oxamocarb, oxyfenthiin, pentachlorophenol and salts, 2-phenylphenol and salts, piperalin, propanosine-sodium, proquinazid, pyrrolnitrin, quintozene, tecloftalam, tecnazene, triazoxide, trichlamide, zarilamid and 2,3,5,6-tetrachloro-4-(methylsulphonyl)pyridine, N-(4-chloro-2-nitrophenyl)-N-ethyl-4-methylbenzenesulphonamide, 2-amino-4-methyl-N-phenyl-5-thiazolecarboxamide, 2-chloro-N-(2,3-dihydro-1,1,3-trimethyl-1H-inden-4-yl)-3-pyridinecarboxam-ide, 3-[5-(4-chlorophenyl)-2,3-dimethylisoxazolidin-3-yl]pyridine, cis-1-(4-chlorophenyl)-2-(1H-1,2,4-triazol-1-yl)cycloheptanol, 2,4-dihydro-5-methoxy-2-methyl-4-[[[[1-[3-(trifluoromethyl)phenyl Iethylid-enejamino]oxy]methyl]phenyl]-3H -1,2,3-triazol-3-one (185336-79-2), methyl 1-(2,3-dihydro-2,2-dimethyl-1H-inden-1-yl) -1H-imidazole-5-carboxylate, 3,4,5-trichloro-2,6-pyrdinedicarbonitrile, methyl 2-[[[cyclopropyl[(4-methoxyphenyl)imino]methyl]thio]methyl]-.alpha.-(meth-oxyrnethylene)benzacetate, 4-chloro-alpha-propynyloxy-N-[2-[3-methoxy-4-(2-propynyloxy)phenyllethyl]-benzacetamide, (2S)—N-[2-[4-[[3-(4-chlorophenyl)-2-propynylioxyl-3-methoxyphenyllethyl[-3-methyl-2-[(methylsulphonyl)arnino]butanamide, 5-chloro-7-(4-rnethylpiperidin-1-yl)-6-(2,4,6-trifluorophenyl) [1,2,4]-triazolo[1,5-alpyrirnidine, 5-chloro-6-(2,4,6-trifluorophenyl)-N-[(1R)-1,2,2-trimethylpropyli-[1,2,4]-triazolo[1,5-a]pyrimidine-7-amine, 5-chloro-N-[(1R)-1,2-dimethylpropyl]-6-(2,4,6-trifluorophenyl)[1,2,4[triazolo[1,5-alpyrimidine-7-amine, N-[1-(5-bromo-3-chloropyridin-2-yl)ethyl]-2,4-dichloronicotinamide, N-(5-brorno-3-chloropyridin-2-yl)methyl-2,4-dichloronicotinamicle, 2-butoxy-6-lodo-3-propylbenzopyranon-4-one, N-{(Z)-[(cyclopropylmethoxy)-imino][6-(difluoromethoxy)-2,3-difluorophenyl]methyl]-2-benzacetamide, N-(3-ethyl-3,5,5-trimethylcyclohexyl)-3-formylamino-2-hydroxybenzamide, 2-[[[[1[3-(1-fluoro-2 -phenlylethyl)oxy]phenyl]ethylidene]amino]oxy]methyl]-alpha-(methoxylmino)-N-methyl-alphaE-benzaretamide, N-{2-{3-chloro-5-(trifluoromethyl)pyridin-2-yl]ethyll-2-(trifluoromethyl)-benzamide, N-(3′,4′-dichloro-5-fluorobiphenyl-2-yl)-3-(difluoromethyl)-1-m-ethyl-1H-pyrazole-4-carboxam ide, N-(6-methoxy-3-pyridinyl)cyclopropanecarboxamide, 1-[(4-methoxyphenoxy)methyl]-2,2-dimethylpropyl]-1H-imidazole-1-carboxylic acid, O-[1-[(4-methoxyphenoxy)methyl]-2,2-dimethylpropyl]-1H-imidazole-1-carbothioic acid, 2-(2-{([6-(3-chloro-2-methylphenoxy)-5-fluoropyrimidin-4-yl]oxy]phenyl)-2.-.(methoxyimino)-N-methyl-acetamicle.

Insecticides: Acetylcholine Esterase (AChE) Inhibitors for example, carbamates, for example alanycarb, aldicarb, alcioxycarb, allyxycarb, aminocarb, bendiocarb, benfuracarb, bufencarb, butacarb, butocarboxim, butoxycarboxim, carbaryl, carbofuran, carbosulphan, cloethocarb, dimetilan, ethiofencarb, fenobucarb, fenothiocarb, formetanate, furathiocarb, isoprocarb, metarn-sodium, methiocarb, methomyl, metolcarb, oxamyl, pirimicarb, prornecarb, propoxur, thiodicarb, thiofanox, trimethacarb, XMC, xylylcarb, triazarnate; Acetylcholine Receptor Agonists/Antagonists for example, chloronicotinyls, for example acetamiprid, clothianidln, dinotefuran, imidacloprid, nitenpyram, nithiazine, thiacloprid, thiamethoxam, AKD-1022, imiclaclotiz nicotine, bensultap, cartap; Acetylcholine Receptor Modulators for example, spinosyns, for example spinosad and spinetoram; GABA-controlled Chloride Channel Antagonists for example, organochiorines, for example camphechlor, chlordane, endosulfan, gamma-HCH, HCH, heptachlor, lindane, methoxychlor fiproles, for example acetoprole, ethiprole, fipronil, pyrafluprole, pyriprole, vaniliprole; Active Compounds with Unknown or Unspecific Mechanisms of Action, for example, aluminium phosphide, methyl bromide, sulphuryl fluoride antifeedants, for example cryolite, flonicamid, pymetrozine mite growth inhibitors, for example clofentezine, etoxazole hexythiazox arridoflumet, benclothiaz, benzoximate, bifenazate, bromopropylate, buprofezin, chinomethionat, chlordimeform, chiorobenzilate, chloropicrin, clothiazoben, cycloprene, cyflumetofen, dicyclanii, fenoxacrim, fentrifanil, flubenzimine, flufenerim, flutenzin, gossyplure, hydramethylnone, japonilure, rnetoxacliazone, petroleum, piperonyl butoxide, potassium oleate, pyridalyl, sulfluramid, tetradifon, tetrasul, triarathene, verbutin; Biologicals, Hormones or Pheromones for example, azadirachtin, Bacillus spec., Beauveria spec., codlemone, Metarrhizium spec., Paecilomyces spec., thuringiensin, and Verticillium spec.; Carboxamides, for example, flonicamid octoparninergic agonists, for example arnitraz; Chitin Biosynthesis Inhibitors benzoylureas, for example bistrifluoron, chlofluazuron, diflubenzuron, fluazuron, flucycloxuron, flufenoxuron, hexaflumuron, lufenuron, novaluron, novifiumuron, penfluoron, teflubenzuron, triflumuron buprofezin cyromazine; Chloride Channel Activators mectins, for example abamectin, emamectin, emamectin-benzoate, ivermectin, lepimectin, milbemycin, latidectin, selamectin, doramectin, eprinomectin, rnoxidectin; Lipid Synthesis Inhibitors tetronic acids, for example spirodiclofen, spiromesifen tetrarnic acids, for example spirotetramat, cis-3-(2,5-dimethylphenyl)-4-hydroxy-8-methoxy-1-azaspiro-[4,5]dec-3-en-2-one; DNOC Site-I Electron Transport Inhibitors METIs, for example fenazaquin, fenpyroximate, pyrirnidifen, pyriciaben, tebufenpyrad, tolfenpyrad hydramethylnon dicofol; Ecdysone Agonists/Disruptors diacylhydrazines, for example chromafenozide, halofenozide, methoxyfenozide, tebufenozide; Inhibitors of Magnesium-stimulated ATPase, for example, propargite nereistoxin analogues, for example thiocyclam hydrogen oxalate, thiosultap-sodiurn; Latrophilin Receptor Agonists for example, depsipeptides, such as, for example, cycl, depsipeptide, for example, ernodepside; Juvenile Hormone Mimetics, for example diofenolan, epofenonane, fenoxycarb, hydroprene, kinoprene, methoprene, pyriproxifen, triprene; Organophosphates, for example, acephate, azarnethiphos, azinphos (-methyl, -ethyl), bromophos-ethyl, bromfenvinfos (-methyl), butathiofos, cadusafos, carbophenothion, chlorethoxyfos, chlorfenvinphos, chiormephos, chlorpyrifos (-methyl/-ethyl), coumaphos, cyanofenphos, cyanophos, chlorfenvinphos, demeton-S-methyl, demeton-S-methyslsuphone, dialifos, diazinon, dichlofenthion, dichlorvos/DDVP, dicrotophos, dimethoate, dimethylvinphos, dioxabenzofos, disulfoton, EPN, ethion, ethoprophos, etrimfos, famphur, fenamiphos, fenitrothion, fensulfothion, fenthion, flupyrazofos, fonofos, forrnothion, fosmethilan, fosthiazate, heptenophos, iodofenphos, iprobenfos, isazofos, isofenphos, isopropyl O-salicylate, isoxathion, malathion, mecarbam, methacrifos, methamidophos methidathion, mevinphos, monocrotophos, naled, omethoate, oxydemeton-methyl, parathion (-methyl/-ethyl), phenthoate, phorate, phosalone, phosmet, phosphamidon, phosphocarb, phoxim, pirimiphos (-methyl/-ethyl), profenofos, propaphos, propetamphos, prothiofos, prothoate, pyraclofos, pyridaphenthion, pyridathion, quinalphos, sebufos, sulfotep, sulprofos, tebupirimfos, ternephos, terbufos, tetrachlorvinphos, thiometon, triazophos, triclorfon, vamidothion; Oxidative Phosphorylation Inhibitors, ATP Disruptors for example, diafenthiuron organotin compounds, for example azocyciotin, cyhexatin, fenbutatin-oxide; Oxidative Phosphorylation Decouplers (H-proton Gradient interruptors), for example chlorfenapyr dinitrophenols, for example binapacryl, dinobuton, dinocap; Ryanoclin receptor agonists benzoic acid dicarboxamides, for example flubencliamid anthranilamides, for example rynaxypyr (3-bromo-N-{4-chloro-2-methyl-6-[{methylamino)carbonyi]phenyl)-1-(3-chlor-opyridin-2-yl)-1H-pyrazole-5-carboxarnide); Site-II Electron Transport Inhibitors for example, rotenone, Site-III Electron Transport Inhibitors for example, acequinocyl, fluacrypyrim, and Microbial Disruptors of the Insect Out Membrane Bacillus thuringiensis strains; Sodium Channel Modulators/Voltage-dependent Sodium Channel Blockers, for example acrinathrin, allethrin (d-cis-trans, d-trans), beta-cyfluthrin, bifenthrin, bioallethrin, bioallethrin-S-cyclopentyl isomer, bioethanomethrin, biopemethrin, bioresmethrin, chlovaporthrin, cis-cypermethrin, cis-resmethrin, cis-permethrin, clocythrin, cycloprothrin, cyfluthrin, cyhalothrin, cypermethrin (alpha-, beta-, theta-, zeta-), cyphenothrin, deltamethrin, empenthrin (1R isomer), esfenvalerate, etofenprox, fenfluthrin, fenpropathrin, fenpyrithrin, fenvalerate, flubrocythrinate, flucythrinate, flufenprox, flumethrin, fluvalinate, fubfenprox, gamma-cyhalothrin, imiprothrin, kaciethrin, lambda-cyhalothrin, rnetofluthrin, permethrin (cis-, trans-), phenothrin (1R-trans isomer), praliethrin, profluthrin, protrifenbute, pyresmethrin, resmethrin, RU 15525, silafluofen, tau-fluvalinate, tefluthrin, terallethrin, tetramethrin OR isomer), tralomethrin, transfluthrin, ZXI 8901, pyrethrins (pyrethrum) DDT oxadiazines, for example indoxacarb semicarbazones, for example metaflumizone (BAS3201). Other combinations of actives can be used, in one aspect, the second component comprises a nematicide composition combined with or used sequentially with the first component. Suitable nematicide compositions include, for example, non-fumigant group nematicides and/or fumigant group nematicides. Examples of non-fumigant group nematicides include carbamates for example, Temik (aldicarb); Furadan (carbofuran); Vydate (oxamyl); benomyl, carbosulfan, cloethocarb, and Standak (aldoxycarb). Organophosphate nematicides such as, for example, diamidafos, fenarniphos, fosthietan, and phosphamidon. Organothiophosphate nematicides such as cadusafos, chlorpyrifos, dichloferithion, dimethoate, ethoprophos, fensulfothion, fosthiazate, heterophos, isamidofos, isazofos, phorate, phosphocarb, terbufos, thionazin, and triazophos; Phosphonothioate nematicides such as imicyafos and mecarphon; Dasanit (fensulfothion); Mocap (ethoprop); Nemacur (pheamiphos); and others such as, for example, ClancloSane® (chitan/urea): DiTera® (fungal metabolite) and Avictae® (abamectin). Botanical nematicides such as carvacrol; Oxime carbamate nematicides such as alanycarb, aldicarb, aldoxycarb, oxamyl, and tirpate can be employed as the second component.

In one particular aspect, fumigant nematicides can be used together with (or sequentially) with the first component and include, for example, one or more of aluminium phosphide, sulphuryl fluoride anti-feedants, for example cryolite, flonicamid, pymetrozine mite growth inhibitors, for example clofentezine, etoxazole, hexythiazox amidoflumet, benclothiaz, benzoximate, bifenazate, bromopropylate, buprofezin, chinomethionat, chlordimeform, chlorobenzilate, chloropicrin, clothiazoben cycloprene, cyflumetofen, dicyclanil, fenoxacrim, fentrifanil, flubenzimine, flufenerim, flutenzin, gossyplure, hydramethylnone, japonilure, metoxadiazone, petroleum, piperonyl butoxide potassium oleate, pyridalyl, sulfluramid tetradifon, tetrasul, triarathene, verbutin, neem cake extracts, and Nematophagous fungi (Tagetes).

In another aspect, the first component is used together with a nematicide, for example, Avicta® (abannectin; Syngenta, LLC) Gliocladium roseum, or chitosan. Such combination of first component and nematicide can be synergistic with regard to the combination of chemical constituents, and/or, synergistic with regard to ability of the first component to improve and/or enhance the natural defenses of a plant against parasitic attack and/or stresses directly or indirectly caused by such parasitic attack.

Anti-viral agents can include, for example, agents that are effective for the control or remediation of asymptomatic viruses, protozoa, and parasitic plants in combination with the first component.

The optional component can also include growth regulators, for example, cytokinins, auxins, gibberellins, and combinations thereof with any of the compounds listed above.

The optional component can also comprise one or more plant macronutrients or plant micronutrients. The term “macronutrient” can refer to an element for plant growth, which is utilized by plants in proportionally larger amounts relative to micronutrients. The term “micronutrients” refers to an element utilized by plants during growth, which are used in smaller amounts relative to macronutrients, For example, plant macronutrients include nitrogen, potassium, phosphorus, calcium, magnesium and sulfur. The optional component can comprise various combinations and relative amounts of individual macronutrients. For example, plant micronutrients include iron, manganese, zinc, copper, boron, molybdenum and cobalt. Numerous compounds and substances are available to provide micronutrients as the optional component. Various combinations and relative amounts of micronutrients can be utilized in the optional component. The optional component can also include, in addition to any of the above, a mold inhibitor, an absorbent, a penetrant, and combinations thereof.

Processes for preparing a composition disclosed and described herein typically involve simple admixture of the required ingredients of first and second components. If desired, any of the components can be pre-dissolved in a suitable volume of water before mixing with other components. Order of addition is not generally critical.

### Methods

Methods of use of the composition as described herein for controlling phytoparastic pest populations are further disclosed and provided. The phytoparasitic pest can be an endoparasitic pest and/or an ectoparasitic pest, and is inclusive of nematodes in general. In one aspect, the methods described herein are specific to nematodes in general in other aspects, the methods described herein are specific to genera of nematodes, inclusive of those of interest in causing damage to traditional agronomic plants. The composition comprises the first component and it can be applied to a plant, a single seed or to an assemblage of seeds in bulk or in a continuous process, or the locus of the plant or seed after sowing. In some embodiments, the composition is applied to an agricultural or horticultural seed, more especially a food crop.

Methods disclosed hereinare appropriate both for immediately prior to sowing or for stored seed. The composition is not specific to a particular crop, as the first component is active to the nematode. However, it may be that the first component works synergistically with the plant's defense system to control he nematode population, for example by toxicity and/or repelling.

While the present methods can he beneficial for gramineous (belonging to the grass family) crops such as cereal crops, including corn wheat, barley, oats, rye, triticale, and rice, they are also highly appropriate for non-gramineous crops, including traditional agronomic crops, vegetable crops, fruit crops, oil-producing crops, and seed crops. The terms “fruit” and “vegetable” herein are used in their agricultural or culinary sense, not in a strict botanical sense; for example, tomatoes, cucumbers and zucchini are considered vegetables for present purposes, although botanically speaking it is the fruit of these crops that is consumed. Vegetable crops for which the present methods can be found useful include without limitation:

leafy and salad vegetables such as amaranth, beet greens, bitterleaf, bok choy, Brussels sprout, cabbage, catsear, celtuce, choukwee, Ceyion spinach, chicory, Chinese mallow, chrysanthemum leaf, corn salad, cress, dandelion endive, epazote, fat hen, fiddlehead, fluted pumpkin, golden samphire, Good King Henry ice plant, jambu, kai-lan, kale, komatsuna, kuka, Lagos bologi, land cress, lettuce, lizard's tail, melokhia mizuna greens, mustard, Chinese cabbage, New Zealand spinach, orache, pea leaf, polk, radicchio, rocket (arugula), samphire, sea beet, seakale, Sierra Leone bologi, soko, sorrel, spinach, summer purslane, Swiss chard, tatsoi, turnip greens, watercress, water spinach, winter purslane and you choy;

flowering and fruiting vegetables such as acorn squash, Armenian cucumber, avocado, bell pepper, bitter melon, butternut squash, caigua, Cape gooseberry, cayenne pepper, chayote, chili pepper, cucumber, eggplant (aubergine), globe artichoke, luffa, Malabar gourd, parwal, pattypan squash, perennial cucumber, pumpkin, snake gourd, squash (marrow), sweetcom, sweet pepper, tinda, tomato, tomatillo, winter melon, West Indian gherkin and zucchini (courgette);

podded vegetables (legumes) such as American groundnut, azuki bean, black bean, black-eyed pea, chickpea (garbanzo bean), drumstick, dolichos bean, fava bean (broad bean), French bean, guar, haricot bean, horse gram, Indian pea, kidney bean, lentil, lima bean, moth bean, mung bean, navy bean, okra, pea, peanut (groundnut), pigeon pea, pinto bean, rice bean, runner bean, soybean, tarwi, tepary bean, urad bean, velvet bean, winged bean and yardlong bean;

bulb and stem vegetables such as asparagus, cardoon, celeriac, celery, elephant garlic, fennel, garlic, kohlrabi, kurrat, leek, lotus root, nopal, onion, Prussian asparagus, shallot, Welsh onion and wild leek;

root and tuber vegetables, such as ahipa, arracacha, bamboo shoot, beetroot, black cumin, burdock, broadleaf arrowhead, camas, canna, carrot, cassava, Chinese artichoke, daikon, earthnut pea, elephant-foot yam, ensete, ginger, gobo, Hamburg parsley, horseradish, Jerusalem artichoke, jicama, parsnip, pignut, plectranthus, potato, prairie turnip, radish, rutabaga (swede), salsify, scorzonera, skirret, sweet potato, taro, ti, tigernut, turnip, ulluco, wasabi, water chestnut, yacon and yam; and

herbs, such as angelica, anise, basil, bergamot, caraway, cardamom, chamomile, chives, cilantro, coriander, dill, fennel, ginseng, jasmine, lavender, lemon balm, lemon basil, lemongrass, marjoram, mint, oregano, parsley, poppy, saffron, sage, star anise, tarragon, thyme, turmeric and vanilla.

Fruit crops for which the present methods can be found useful include without limitation apple, apricot, banana, blackberry, blackcurrant, blueberry, boysenberry, cantaloupe, cherry, citron, clementine, cranberry, damson, dragonfruit, fig, grape, grapefruit, greengage, gooseberry, guava, honeydew, jackfruit, key lime, kiwifruit, kumquat, lemon, lime, loganberry, longan, loquat, mandarin, mango, marigosteen, melon, muskmelon, olive, orange, papaya, peach, pear, persimmon, pineapple, plantain, plum, pomelo, prickly pear, quince, raspberry, redcurrant, starfruit, strawberry, tangelo, tangerine, tayberry, ugli fruit and watermelon.

Seed crops, for example, specialized crops used to produce seed of any plant species, for which the present methods can be found useful include, in addition to cereals (e.g, barley, corn (maize), millet, oats, rice, rye, sorghum (milo) and wheat), non-gramineous seed crops such as buckwheat, cotton, flaxseed (linseed), mustard, poppy, rapeseed (including canola), safflower, sesame and sunflower.

Other crops, not fitting any of the above categories, for which the present methods can be found useful include without limitation, sugar beet, sugar cane, hops, and tobacco.

Each of the crops listed above has its own particular nematode protection needs, Further optimization of compositions described herein for particular crops can readily be undertaken by those of skill in the art, based on the present disclosure, without undue experimentation.

Methods of using the compositions disclosed and described herein comprise applying a composition as described herein to a seed or plant, or to a locus of the seed or plant. In one aspect, the compositions disclosed and described herein are applied to seeds, applied to the soil either before during or after sowing, and/or applied to the foliage or any part of the emerged plant.

Compositions disclosed and described herein can be provided in concentrate form, (e.g., liquid, gel, or reconstitutable powder form), suitable for further dilution and/or mixing in water prior to application to the seed, plant, or locus. Alternatively, they can be provided as a ready-to-use solution or suspension for direct application. Because compositions disclosed and described herein can be combined with other AI's, such as fertilizer solutions and/or with pesticide solutions, they can be diluted and/or reconstituted by mixing with such other solutions The above concentrate compositions are suitable for further dilution.

### Seed, Foliage, and Locus Treatments or Coatings

Compositions disclosed and described herein useful for nematode population control can be applied using any conventional system for applying liquids to foliage seed, or locus. Most commonly, for seed, application is by tumbling the seed with a liquid or powder form of the composition, which can be introduced to the seed by spraying will be found most convenient. For spraying, any conventional atomization method can be used to generate spray droplets including hydraulic nozzles and rotating disk atomizers combined with the tumbler.

In one aspect, methods for nematode population control is provided that comprises contacting the seeds with an aqueous composition comprising the first component and an optional component selected from one or more pesticides and/or one or more natural plant hormones. The seeds may be contacted with the composition by conventional means such as spraying, rolling, or tumbling in a ntinuous or batch-treating process. Thus, the first component can be combined with the at least one agriculturally acceptable microorganism and an optionai component. Combinations of the first component and the at least one agriculturaily acceptable microorganism can be mixed in aqueous media at a concentration, and brought into contact with the seeds for a time sufficient to provide for nematode population control in the intended locus of planting.

For seed treatment or seed coatings, the amount of (application rate) the first component can be about 0.1 mL/100 kg seed weight to about 1000 ml/100 kg seed weight. Other concentrations of the compositions disclosed herein can be used. In certain aspects, the application rate can be between about 1 mL/100 kg seed to about 100 mL/100 kg seed; preferably about 10 mL/100 kg seed to about 75 mL/100 kg seed.

For foliage surface or locus applications, the application rate of the compositions disclosed herein can be between about 0.01 gram/hectare to about 10.0 gram/hectare dry weight, between about 0.2 gram/hectare to about 2.0 gram/hectare dry weight, between 0.3 gram/hectare to about 1.5 gram/hectare dry weight, or between about 0.4 gram/hectare to about 1.0 gram/hectare dry weight applied in the soil or as a foliar application to the foliage or the locus of the plant. Other concentrations of the compositions disclosed herein can be used. In one aspect, absorption of the applied composition typically occurs at the site of application on a foliar surface, but the applied composition can run down to other areas and be absorbed there. Runoff (where an applied solution is shed from foliar surfaces and reaches the soil or other growing medium of the plant) is generally undesirable, but the applied nutrient is generally not totally lost as it can be absorbed by the plant's root system anytime during the expected life of the plant. However, methods of application that minimize runoff are preferred, and are well known to those of skill in the art.

Application solutions prepared by using (or diluting) concentrate compositions as described above represent further aspects of the compositions and methods disclosed and described herein.

For seed treatment applications, a concentrate composition can be diluted up to about 600-fold or more with water, more typically up to about 100-fold or up to about 40-fold. Illustratively, a concentrate product can be applied at about 0.01 mg/Kg seed to about 10 mg/Kg seed, for example about 0.1 mg/Kg seed, 0.5 mg/Kg seed, 2.5 mg/Kg seed or a higher amount. Other concentrations of the compositions disclosed herein can be used

For application to plant foliage, a concentrate composition can be diluted up to about 600-fold or more with water, more typically up to about 100-fold or up to about 40-fold. Illustratively, a concentrate product can be applied at about 0.1 to about 30 liter/hectare (1/ha), for example about 5 to about 25 1/ha, in a total application volume after dilution of about 60 to about 600 l/ha, for example about 80 to about 400 1/ha or about 100 to about 200 1/ha Other concentrations of the concentrate compositions disclosed herein can be used

For seed treatment applications, a concentrate composition can be diluted up to about 600-fold or more with water, more typically up to about 100-fold or up to about 40-fold. Illustratively, a concentrate product can be applied at about 0.1 mg/Kg seed to about 100 mg/Kg seed, for example about 0.1 mg/Kg seed, 1 mg/Kg seed, 10 mg/Kg seed, Other concentrations of the concentrate compositions disclosed herein can be used

The compositions disclosed herein can be applied in a sequential order, for example, the seeds, plant, or (and then) its locus can be contacted with the first component, and optionally at least one pesticide and the post-emergent plant or its locus can be contacted with the first component and optionally at least one pesticide. The frequency of an application and rate of the compositions disclosed and described herein can be varied depending on many factors. it may be advantageous to apply a relatively high “starter” rate, followed by one or more subsequent applications at a lower rate. Application frequency can be, for example, a single application up to three applications per season. In certain situations, a single application will suffice. In other situations, the first and/or second and/or third application may precede, supersede, or correspond to a particular growth cycle of the plant, or a known life cycle or endemic habit of the nematode.

In another aspect, methods of controlling nematode populations is provided that comprises applying to the seeds, plants or locus a coating or dressing of a polymer or other matrix, the polymer or matrix comprising the first component, optionally one or more pesticides and/or one or more natural plant hormones. The polymer or matrix is capable of releasing the first component and, optionally one or more pesticides and/or one or more natural plant hormones (collectively, “the actives”). The polymer or matrix can be designed to release the actives in response to temperature, moisture content, sunlight, time, or combinations thereof. The polymer or matrix can quickly dissolve or disintegrate releasing the actives or can controllable release the actives over time or in response to a predetermined condition such as temperature, moisture content, sunlight, time, or combinations thereof. The polymer or matrix can be multi-layer, with discrete layers, for example, for disrupting the coating to allow moisture ingress, housing the actives, etc. Suitable polymers or matrixes include hydrogels, rnicrogels, or sol-gels. Specific materials (including complete formulations) and methods of coatings seeds useful in this regard include such process and materials as used, for example, intellicoat™ (Landec Inc., Indiana); ThermoSeed™ (Incoter, Netherlands) CelPril™ Poncho™, Poncho/VOTiVo™ (Bayer CropScience); ApronlVlaxx™ (Syngenta); and Nacret™ (Syngenta). The actives can be provided as nanoparticles and incorporated into the polymer or matrix, or directly adhered to the seed coat. The thickness of the polymer or matrix coating may be between from about 0.01 mils to about 10 mils in thickness. The coating can further provide protection for the seeds from mechanical and environmental damages and can facilitate the drilling process.

For seed treatment or seed coatings as described above, the amount of the first component can be about 0.01 mg/kg seed weight to about 10 mg/kg seed weight, however, higher rates can be employed.

### Compositions for Nematode Population Control

Controlling plant-parasitic nematode populations at the locus of a seed and or plant will improve nodulation, germination, root development, emergence, and health, particularly resistance to or protection from disease, especially bacterial or fungal disease, which is an important benefit of methods disclosed and described herein. Methods as described in detail above are useful for controlling parasitic nematode populations, which provide improved general plant health, nutrition and/or improved agronomical benefit of a plant and/or seed. Any benefit related to nematode population control, such as for example, reduction in total number/area of nematode, reduction in nematode eggs/area, reduction in damage to the plant, can be an agronomical benefit of the present methods. Secondary benefits of controlling the nematode population include, without limitation, improved root development (e.g improved root or root hair growth), higher quality produce, improved growth and/or a longer growing season (which in either case can lead to higher yield of produce), faster emergence, improved plant stress management including increased stress tolerance and/or improved recovery from stress, increased mechanical strength, improved drought resistance, reduced fungal disease infection, and improved plant health. Combinations of any of these benefits can be obtained.

### Trial 1. Efficacy for Reniform Nematode Control

Trial 1 was conducted in clay pots (10.1 cm-d) using a steam pasteurized Smithdale sandy loam topsoil (pH=6.5). A reniform nematode, Rotylenchulus reniformis, was used, obtained from Dr. R. T. Robbins at the University of Arkansas, from a population maintained on ‘Braxton’ soybean in a greenhouse, and infested soil from these cultures was used to infest the pots for this trial. Experimental design was as randomized complete block with 6 replications of each treatment (Table 1-1). Each pot was filled with a mixture of 150 cm3 of stock culture soil containing 2,100 vermiform reniform nematodes +350 cm3 pasteurized Smithdale sandy loam, and to each pot two cotton seeds (Phytogen 375 WNR) were planted. All pots were watered immediately after planting and allowed to stand on a greenhouse bench for ten (10) days and then seedlings were thinned to a single plant per pot. Plants were watered as needed by hand. These plants were allowed to grow on a greenhouse bench approximately 48 days. A complete fertilizer (Osrnocoat®) was applied (0.5 g/pot) at 18 days to all pots. No insect control was used during the trial. A control group treated with commercially available nematicide Activa™ (Syngenta) as directed by the label, was used as a control.

On day 48 from initiation of Trial 1, the height of each plant was measured from the cotyledonary node to terminal, then plants were excised at the cotyledonary node and placed individually into small paper bags that were placed into a tissue dryer (60 C) for 48 hr. Root systems were carefully removed from each pot, shaken gently free of soil, and stored in plastic bags in a refrigerator at 4 C until processed. Soil was collected from each pot, thoroughly mixed, and a 50 cm3 sub-sample was extracted using a Baermann funnel for 48 hr. Vermiform R. reniformis that were collected in the funnel were quantified using a dissecting microscope. Roots were extracted at 55 days by placing each intact root system into a 250 flask and shaking it in 200 ml of a 10 percent bleach (0.05 percent NaOCI) solution for 4 minutes. Eggs that were dislodged from the roots and freed from the egg masses were collected on a 500-mesh (26 micron) sieve and counted using 60-80×magnification.

TABLE 1-1
Treatments and rates used to evaluate the efficacy of the first component
as a seed treatment for control of Rotylenchulus reniformis.

| | | | Treatment | Application |
|---|---|---|---|---|
| Treatment | Rate | | Method | Frequency |
| Nematode free | n/a | | n/a | n/a |
| check/untreated | | | | |
| Nematode infested/ | n/a | | n/a | n/a |
| untreated | | | | |
| first component | 13 | mL/100 kg seed | Seed | 1x |
| first component | 26 | mL/100 kg seed | Seed | 1x |
| first component | 52 | mL/100 kg seed | Seed | 1x |
| Avicta ™ 500 FS | 0.15 | mg a.i./seed | Seed | 1x |

Results and Discussion—Cotton plant height was corn parable with the nernatode-free control for all seed treatments, but only first component at 52 ml/100 kg seed was significantly higher than the nematode-infested control as shown in Table 1-2. Similarly, all seed treatments except Aviita™ resulted in plant dry weights that were comparable with the nematode-free control. There were no difference between first component treatments 13 mL/100 kg seed and 26 mL/100 kg seed and Avicta™, but the highest rate of first component resulted in plant dry weights that were higher than with the nematode-infested control and Avictarm™.

TABLE 1-2
Cotton plant height and dry weight after treatment with
first component at varying rates.

| Treatment/sample | Plant Height (cm) | Plant Dry Weight (g) |
|---|---|---|
| Nematode free | 6.8 ab¹ | 0.45 a¹ |
| Untreated/nematode | 4.8 c | 0.29 b |
| infested | | |
| First component (13 mL) | 6.1 abc | 0.37 ab |
| First component (26 mL) | 6.3 abc | 0.40 ab |
| First component (52 mL) | 7.4 a | 0.48 a |
| Avicta (control) | 5.2 bc | 0.30 b |

¹Means within columns followed by the same letter do not differ at P = 0.05 by LSD

TABLE 1-3
Number of vermiform nematodes, eggs, and total reniform nematode
population after treatment with first component at varying rates.

| Treatment/sampLe | Vermiform/500 cm3 | Eggs/root |
|---|---|---|
| Nematode free | 0 c¹ | 0 c¹ |
| Untreated/nematode | 20,083 a | 9,260 a |
| infested | | |
| First component | 9,122 bc | 7,700 ab |
| (13 mL/100 kg seed) | | |
| First component | 19,201 ab | 5,323 b |
| (26 mL/100 kg seed) | | |
| First component | 13,653 ab | 8,605 a |
| (52 mL/100 kg seed) | | |
| Avicta ™ (control) | 14,798 ab | 8,087 ab |

¹Means within columns followed by the same letter do not differ at P = 0.05 by LSD

The data from Table 1-3 shows that first component at 13 mL/100 kg seed suppressed the vermiform-reniform nematode population density in pots cornpared with the nematode-infested control, but none of the other treatments resulted in nematode densities that were statistically lower than the infested sample, whereas only first component at 26 mL/100 kg seed resulted in statistically significant lower nematode egg production than that of the infested sample (Table 1-3). There were no clear trends in this experiment relative to efficacy of either first component or the commercial control (Avicta™) in reniform nematode population suppression.

### Trial 2—Efficacy for Root-Knot Nematodes

Cucumber is one of the most susceptible hosts for root-knot nematodes. Thus, Trial 2 was conducted in clay pots (10.1 cm-d) using a 50-50 (v/v) mixture of steam pasteurized Smithdale sandy loam topsoil and fine quartz sand (pH=6.5). The Meioidogyne incognita (host race 3) was a stock culture maintained by the University of Arkansas Southwest Research & Extension Center in a greenhouse on “Rutgers” tomato. Experimental design was a randomized complete block with 6 replications of each treatment. Two cucumber seeds (Straight Eight) of the appropriate treatment (Table 2-1) were planted into each pot and pots were watered. Seedlings were allowed to emerge and one seedling was removed from each pot after seven (7) days from initiation of Trial 2. Inoculum of M. incognito was prepared by washing roots of infected tomatoes free of soil, cutting galled roots into 2-4 cm length segments, and extracting eggs from egg masses by agitating the root segments in a 0.05 percent NaOCl solution for 3 minutes and collecting the eggs freed from egg masses on a 500-mesh (26p) sieve. Eggs were quantified and 2500 were pipetted into each pot in 5 ml water immediately after seeds were planted. Pots were watered gently with approximately 100 ml of tapwater immediately after inoculation to settle the eggs into the root zone. Plants were watered as needed by hand. Fertilizer (0.5 g Osmocoat®) was applied to each pot at 10 days from initiation of Trial 2. The plants were allowed to grow on a greenhouse bench for about 37 days. No insect control was used during Trial 2.

At 37 days, the height of each plant was measured from soil line to terminal and each plant was removed from its pot. The soil was rinsed gently from the root system, and root galling severity was rated according to the scale: 0-100 where 0=no galls present and 100=100 percent of the root system galled. Plants were then cut at the soil line. Tops were placed individually into small paper bags, which were dried in a tissue dryer (60 C) for 48 hours. Root systems were agitated briskly for 4 minutes in a 0.05 percent NaOCl solution and eggs were collected on a 26p sieve. Eggs were then rinsed in tapwater, stained with acid fuchsin+acetic acid and counted (at 60×magnification). Results are discussed below.

TABLE 2-1
Treatments and rates used to evaluate the efficacy of the first component
as a seed treatment for control of Meloidogyne incognita.

| | | Treatment | Application |
|---|---|---|---|
| Treatment | Rate | Method | Frequency |
| Nematode free | n/a | n/a | n/a |
| check/untreated | | | |
| Nematode Infested/ | n/a | n/a | n/a |
| untreated | | | |
| first component | 13 mL/100 kg seed | Seed | lx |
| first component | 26 mL/100 kg seed | Seed | lx |
| first component | 52 mL/100 kg seed | Seed | lx |
| Avicta ™ 500 FS | 0.15 mg a.i./seed | Seed | lx |

Results and Discussion—Plant height was greatest in the nematode-free control and there were no differences among treatments in plant dry weight (Table 2-2). Root galling severity where nematodes were introduced ranged from 67-88 percent. All seed treatments resulted in less severe galling than the untreated/nematode-infested sample, but there were no differences among seed treatments relative to galling severity at P=0.05 (Table 2-3). Both the Avictam™ 500 standard treatment control and treatment with first component at 13 mL resulted in lower total egg production per root system (Table 2-3); however, when nematode reproduction was adjusted according to root weight i.e., the number of M. incognita eggs that were produced per 0.1 g dry cucumber root, there were no differences among the three first component treatments. Avicta™ 500 resulted in lower numbers of eggs/0.1 g dry root tissue than treatment with first component (52 ml).

The fact that all of the seed treatments resulted in lower galling severity that was lower than with the nematode-infested control indicates that all of the a.i.'s had a measurable effect on nematode population control and reduction of nematode effect on the plants. Although not significant at P=0.05, all of the seed treatments also resulted in a decline in total eggs/root system relative to the nematode-infested control. However, when nematode reproduction was considered in relation to root dry weight (eggs/0.1 g root dry wt.), only first component at the lowest rate (13 mL) and Avicta™ 500 were numerically lower than the infested control, and none of the seed treatments were significantly lower than the non-infested control.

TABLE 2-2
Cucumber plant height and dry weight after treatment
with first component at varying rates.

| Treatment | Plant Height (cm) | Plant Dry Weight (g) |
|---|---|---|
| Nematode free | 7.5 a¹ | 0.53 a¹ |
| Untreated/nematode | 5.8 b | 0.39 a |
| First component | 5.5 b | 0.41 a |
| (13 mL/100 kg seed) | | |
| First component | 5.6 b | 0.29 a |
| (26 mL/100 kg seed) | | |
| First component | 5.7 b | 0.42 a |
| (52 mL/100 kg seed) | | |
| Avicta ™ (control) | 4.8 b | 0.46 a |

¹Means within columns followed by the same letter do not differ at P = 0.05 by LSD

TABLE 2-3
Root galling, eggs/root system, and eggs/0.1 dry root tissue after
seed treatment with first component at varying rates.

| Treatment | Root Galling¹ | Vermiform/500 cm3 | Eggs/root |
|---|---|---|---|
| Nematode free | 0 b² | 0 d² | 0 c² |
| Untreated/nematode | 98 a | 86,133 a | 93,189 ab |
| First component | 86 b | 40,694 bc | 59,647 ab |
| (13 mL/100 kg seed) | | | |
| First component | 72 b | 58,250 ab | 91,735 ab |
| (26 mL/100 kg seed) | | | |
| First component | 67 b | 59,528 ab | 98,712 a |
| (52 mL/100 kg seed) | | | |
| Avicta ™ (control) | 67 b | 22,528 cd | 51,077 b |

¹Rating scale of 0-100, where 0 = no galls and 100 = 100 percent of root system galled.
²Means within columns followed by the same letter do not differ at P = 0.05 by LSD

### Trial 3—Efficacy for Cyst Nematodes

Trial 3 was conducted in clay pots (10.1 cm-d) using a 50-50 (v/v) mixture of steam pasteurized Smithdale sandy loam topsoil and fine quartz sand (pH=6.5). A soybean cyst nematode, Heterodera glycines (race 3), was used, obtained from a stock culture maintained by the University of Arkansas Southwest Research & Extension Center in a greenhouse on “Lee” soybean. Experimental design was a randomized complete block with 6 replications of each treatment. Two soybean seeds (Armor 47F8) of the appropriate treatment (Table 3-1) were planted into each pot and pots were watered, inoculum of H. glycines was prepared by washing roots of infected soybean plants over a 60-mesh sieve, collecting the cysts and mature females, and crushing the cysts with a glass tissue homogenizer to free the eggs. Eggs were quantified and 3,500 were pipetted into each pot in 5 ml water. Pots were watered gently with approximately 100 ml of tapwater immediately after inoculation to settle the eggs into the root zone. Seedlings were allowed to emerge and one seedling was removed from each pot at day 6 from initiation of Trial 3. Plants were watered as needed by hand. No fertilizer was applied. Remaining plants were allowed to grow on a greenhouse bench for at least 4 days. No insect control was used during Trial 3.

On day 43, the height of each plant was measured from the cotyieclionary node to terminal, then plants were excised at the cotyledonary node and placed individually into small paper bags and placed into a tissue dryer (60 C) for 48 hr. Root systems were carefully removed from each pot, shaken gently free of soil, and rinsed over a 60 mesh sieve nested over a 100 mesh sieve using a high pressure spray and sufficient agitation to dislodge the cysts and mature females from the roots. The cysts/mature females were collected from both sieves and counted using a dissecting microscope (30×). They were then placed into a ground glass tissue homogenizer and crushed to free the eggs. Eggs were stained with acid fuchsin + acetic acid to facilitate detection and counted (at 60 ×). Soil from the pots was processed using decanting-sieving and sugar flotation to detect any second-stage juveniles (J2) that remained in the soil, but J2 numbers were extremely low and erratic (data not shown) indicating that eggs in cysts had not had sufficient time to hatch and for J2 to emerge into the soil.

TABLE 3-1
Treatments and rates used to evaluate the efficacy of the first component
as a seed treatment for control of Heterodera glycines.

| | | | Treatment | Application |
|---|---|---|---|---|
| Treatment | | Rate | Method | Frequency |
| 1. | Nematode free | n/a | n/a | n/a |
| | check/ | | | |
| | untreated | | | |
| 2. | Nematode | n/a | n/a | n/a |
| | Infested/ | | | |
| | untreated | | | |
| 3. | first component | 13 ml/100 kg seed | Seed | 1x |
| 4. | first component | 26 ml/100 kg seed | Seed | 1x |
| 5. | first Component | 52 ml/100 kg seed | Seed | 1x |
| 6. | Avicta ™ 500 FS | 0.15 mg a.i./seed | Seed | 1x |

Results and Discussion. Plant height and dry weight was greatest in the nematode-free control (Table 3-2). Treatment 3 resulted in shorter plants than the nematode-free control, and plant weights for treatments 2, 3, and 5 were lower than with the nematode-free control. Treatment with first component at the 26 ml/kg rate and treatment with Avictan™ 500 FS resulted in plant dry weight that was comparable with the nematode-free control plants. All seed treatments resulted in significantly lower numbers of cysts than for the untreated/nematode-infested control (Table 3-2). Both of the higher rates of first component resulted in cyst numbers that were comparable with Avicta™. In general, the data shows seed treatments with the first component reduced the number of eggs per root system by about 50 percent. Treatment with first component at 26 ml/kg resulted in egg numbers that were significantly lower than for the nematode-infested control and comparable to the Avicta™ control treatment.

Treatment of soybean seed with first component at rates ranging from 13-52 mL/kg seed lowered Heterodera glycines reproduction during the first nematode generation. This was seen both in a reduction in the number of cysts that developed on the roots and by a suppression of the number of eggs that were produced by those females. The degree of suppression of nematode infection and reproduction was comparable with the use of Avicta™ 500 FS as a seed treatment. These data imply that the first component is an effective nematicide and/or capable of nematode population control.

TABLE 3-2
Soybean plant height and dry weight after treatment
with first component at varying rates.

| Treatment | Plant Height (cm) | Plant Dry Weight (g) |
|---|---|---|
| Nematode free | 15.5 a¹ | 0.96 a¹ |
| Untreated/nematode | 13.0 ab | 0.48 b |
| First component | 12.4 b | 0.41 b |
| (13 mL/100 kg seed) | | |
| First component | 14.1 ab | 0.75 ab |
| (26 mL/100 kg seed) | | |
| First component | 13.0 ab | 0.57 b |
| (52 mL/100 kg seed) | | |
| Avicta ™ (control) | 14.7 ab | 0.79 ab |

¹Means within columns followed by the same letter do not differ at P = 0.05 by LSD

TABLE 3-3
Number of cysts and mature females, and number of total eggs per
root system after treatment with first component at varying rates.

| Treatment | Cysts/root | Eggs/root |
|---|---|---|
| Nematode free | 0 d¹ | 0 c¹ |
| Untreated/nematode | 197 a | 15,449 a |
| First component | 110 b | 8,495 ab |
| (13 mL/100 kg seed) | | |
| First component | 67 bc | 6,233 bc |
| (26 mL/100 kg seed) | | |
| First component | 76 bc | 9,286 ab |
| (52 mL/100 kg seed) | | |
| Avicta ™ (control) | 51 cd | 4,686 bc |

¹Means within columns followed by the same letter do not differ at P = 0.05 by LSD

The above seed treatments indicate the first component is an effective nematode population control active across a broad spectrum of nematode species. As the first component is relatively stable to environmental condtions, a soil and/or foliar treatment would yield comparable results, and could be combined with seed treatment if desired. Thus, a method for controlling a population of nematode in the general locus of a plant or seed is achieved by contacting the on or seed or plant with the first component and optionally a second component in an amount that controls the nernotode population of the loci, for example, by the obse.rvable improvement in the germination, emergence, root development or vigor of the seed or plant as compared to a seed or loci not contacted with the composition disclosed herein.

All patents and publications cited herein are incorporated by reference into this application in their entirety.

The words “comprise”, “comprises”, and “comprising” are to be interpreted inclusively rather than exclusively.

1. A composition for managing a phytoparasitic pest population, the composition comprising:
a first component comprising an amount of dissolved organic material (DOM), the DOM consisting essentially of:
a concentrate of organic material characterized by at least two of:
a mixture of condensed hydrocarbons, lignins, and tannins and/or condensed tannins, and one or more trace metals;
an oxygen-to-carbon ratio for the dissolved organic matter of greater than about 0.5;
a total number of tannin compounds greater than about 200, the tannin compounds having a hydrogen to carbon ration of about 0.5 to about 1.4, and an aromaticity index of less than about 0.7 as measured by mass spectroscopy; or
a percent mass distribution of about 47-56 percent lignin compounds, 33-42 percent tannin compounds, and about 8-11 percent condensed hydrocarbon as measured by mass spectroscopy.

2. The composition of claim 1, wherein the concentrate of organic material is a mixture of condensed hydrocarbons, lignins, and tannins and/or condensed tannins, characterized in that at least 20 percent of the total percent of compounds of the composition are tannins and/or condensed tannins.

3. The composition of claim 1, wherein the concentrate of organic material is characterized by comprising a mixture of condensed hydrocarbons, lignins, and tannins and/or condensed tannins, characterized in that at least 10 percent of the total percent of compounds of the composition are tannins and/or condensed tannins.

4. The composition of claim 1, wherein the DOM is concentrated at least 5× from its source of origin.

5. The composition of claim 1, further comprising at least one of an insecticide, attractant, sterilizing agent, bactericide, acaricide, nematicide, fungicide, growth-regulating substance, herbicide, safener, fertilizer, and/or semiochemical.

6. The composition of claim 1, wherein the first component and the at least one an insecticide, attractant, sterilizing agent, bactericide, acaricide, nematicide, fungicide, growth-regulating substance, herbicide, safener, fertilizer, semiochemical, and combinations thereof are releasably contained in a polymer matrix.

7. The composition of claim 1, further comprising extender, liquid solvent, solid carrier, surfactant, emulsifier, dispersant, tackifier, and/or colorant.

8. A method for management of phytoparasitic pests on a seed, plant, or locus thereof, the method comprising:
introducing an amount of the concentrate of DOM as defined in claim 1 to a seed, plant, and/or locus of a seed or a plant, wherein the amount of the concentrate of DOM is effective in reducing or eliminating damage to the seed or the plant caused directly or indirectly from the phytoparasitic pest.

9. The method of claim 8, wherein the phytoparasitic pest is an endoparasitic pest and/or an ectoparasitic pest.

10. The method of claim 8, wherein the effect amount of the concentrate of DOM is effective in reducing or eliminating total adult, juvenile, and/or egg population of the phytoparasitic pest in or on the seed or the plant, or the locus of the seed or the plant.

11. The method of claim 8, wherein the phytoparasitic pest is selected from the phylum Nematoda.

12. The method according to claim 11, wherein the phyla of Nematoda is one or more of Meloidogyne; Pratylenchus; Heterodera; Ditylenchus; Globodera; Tylenchulus; Xiphinema; Radopholus; Rotylenchulus; and Helicotylenchus.

13. The method of claim 8, where the plant or the seed is of a legume crop.

14. The method of claim 8, wherein the plant or the seed is of a fruit or vegetable crop.

15. The method of claim 8, wherein the plant or the seed is of a grain or oil seed crop.

16. The method of claim 8, where the plant or the seed is of selected from a grains, grasses, oil seed, agronomic crops, or brassica.

17. The method of claim 8, wherein the plant or the seed is genetically modified.

18. The composition of claim 1 contacted with one or more seeds.

19. The composition of claim 18, where the seed is selected from grains, grasses, oil seed, agronomic crops, or brassica, and/or the seed is genetically modified.
